(19) United States
(12) Patent Application Publication
(10) Pub. No.: US 2023/0238911 A1
(43) Pub. Date: Jul. 27, 2023

(54) MOTOR CONTROL SYSTEM AND MOTOR CONTROL METHOD

(71) Applicant: Hitachi Astemo, Ltd., Hitachinaka-shi, Ibaraki (JP)

(72) Inventors: Yuji KOBAYASHI, Hitachinaka-shi (JP); Yasuyuki SAITO, Hitachinaka-shi (JP); Takayuki NITTA, Hitachinaka-shi (JP); Yoshinori AOSHIMA, Hitachinaka-shi (JP); Hiroyuki TAKEMOTO, Hitachinaka-shi (JP)

(73) Assignee: Hitachi Astemo, Ltd., Hitachinaka-shi, Ibaraki (JP)

(21) Appl. No.: 17/928,733

(22) PCT Filed: Jun. 10, 2021
(86) PCT No.: PCT/JP2021/022190

§ 371 Date: Nov. 30, 2022

(30) Foreign Application Priority Data
Jul. 6, 2020 (JP) 2020-116690

(51) Int. Cl. H02P 29/64; G01K 7/22; B60W 10/08; H02P 6/08; B60L 3/00

(52) U.S. Cl. CPC H02P 29/64; G01K 7/22; B60W 10/08; H02P 6/08; B60L 3/0061

(57) ABSTRACT

A motor control system includes a three-phase motor winding; and a thermistor that measures a temperature of any one or two of coils of the three-phase motor winding, the motor control system including a coil temperature estimation unit that calculates an estimated temperature of each of the three-phase coils based on a value of a current flowing through the three-phase motor winding. The motor is controlled based on the estimated temperature of the three-phase motor winding when a difference between the estimated temperatures of the three-phase motor winding is larger than a predetermined value. The motor is controlled based on a measured value of the thermistor when the difference between the estimated temperatures of the three-phase motor winding is equal to or less than the predetermined value.

### TECHNICAL FIELD

The present invention relates to a motor control system and a motor control method.

### BACKGROUND ART

As a background art of the present invention, the following PTL 1 is known regarding temperature estimation of a motor in motor control. PTL 1 discloses a configuration that includes an estimation error corrector that estimates a temperature distribution or a local maximum temperature in a plurality of regions in an excitation coil, and can accurately perform temperature estimation in consideration of the temperature distribution of the excitation coil.

### CITATION LIST

### Patent Literature

PTL 1: JP 2017-058131 A

### SUMMARY OF INVENTION

### Technical Problem

In the configuration of PTL 1, for example, when the sensors are not attached to all the three phases due to the layout of the motor, when the rotation of the motor is 0 rpm (r/min), a temperature difference occurs due to a difference in calorific value of each of the U-phase, the V-phase, and the W-phase due to the bias of the three-phase current. Therefore, it is difficult to protect the motor only by the conventional protection method using the thermistor.

In view of this, an object of the present invention is to provide a motor control system that enables three-phase overheat protection without providing sensors in all of the U-phase, V-phase, and W-phase of a motor.

### Solution to Problem

A motor control system according to the present invention is a motor control system that controls a motor including a three-phase motor winding including a U-phase coil, a V-phase coil, and a W-phase coil, and a thermistor that measures a temperature of any one or two of the coils of the three-phase motor winding, the motor control system including: a coil temperature estimation unit that calculates an estimated temperature of each of the U-phase coil, the V-phase coil, and the W-phase coil based on a value of a current flowing through the three-phase motor winding. The motor is controlled based on the estimated temperature of the three-phase motor winding when a difference between the estimated temperatures of the three-phase motor winding is larger than a predetermined value. The motor is controlled based on a measured value of the thermistor when the difference between the estimated temperatures of the three-phase motor winding is equal to or less than the predetermined value.

### Advantageous Effects of Invention

According to the present invention, it is possible to provide a motor control system that enables three-phase overheat protection without providing sensors in all of the U-phase, the V-phase, and the W-phase of a motor.

### BRIEF DESCRIPTION OF DRAWINGS

FIG. 1 is a schematic configuration diagram of a hybrid electric vehicle on which a motor of the present embodiment is mounted.

FIG. 2 is a circuit diagram of an inverter device

FIG. 3 is a cross-sectional view of a motor according to the present embodiment.

FIG. 4 is a schematic diagram of a thermal circuit used for temperature estimation calculation.

FIG. 5 is a flowchart in the case of only protection by a thermistor.

FIG. 6 is a flowchart in a case where protection by a thermistor and temperature estimation calculation are combined, and a temperature difference of three-phase estimated values is used for determination of switching.

FIG. 7 is a flowchart in a case where protection by a thermistor and temperature estimation calculation are combined, and a rotation speed and a temperature difference of three-phase estimated values is used for determination of switching.

FIG. 8 is an operation schematic view in the case of only protection by a thermistor.

FIG. 9 is an operation schematic view when protection by a thermistor and protection by temperature estimation calculation are combined.

FIG. 10 illustrates a torque rotation speed characteristic of a motor.

### DESCRIPTION OF EMBODIMENTS

### Configuration of First Embodiment and Motor Control System

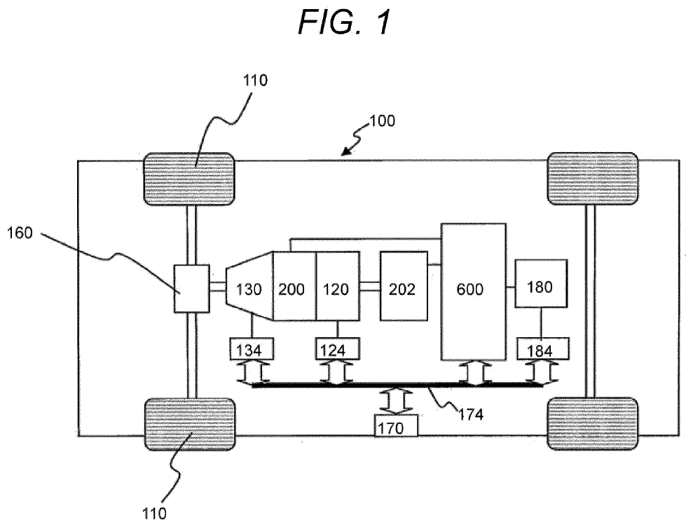

Hereinafter, embodiments of the present invention will be described with reference to the drawings. FIG. 1 is a diagram illustrating a schematic configuration of a hybrid electric vehicle equipped with a motor according to an embodiment of the present invention.

An engine 120, a first motor 200, a second motor 202, and a battery 180 are mounted on a vehicle 100. The transfer of the DC power between the battery 180 and the motors 200 and 202 is performed via the inverter device 600, and the battery 180 supplies the DC power to the motors 200 and 202 when the driving force by the motors 200 and 202 is required. During regenerative traveling, the battery 180 conversely acquires DC power from the motors 200 and 202.

Although not illustrated, a battery for supplying low voltage power (for example, 14-volt system power) is separately mounted on the vehicle 100, and supplies DC power to a control circuit described below.

The rotational torque generated by the engine 120 and the motors 200 and 202 is transmitted to a front wheel tire 110 via a transmission 130 and a differential gear 160. The transmission 130 is controlled by a transmission control device 134. The engine 120 is controlled by an engine control device 124. The battery 180 is controlled by a battery control device 184. The transmission control device 134, the engine control device 124, the battery control device 184, the inverter device 600, and an integrated control device 170 are connected via a communication line 174.

The battery 180 having a high voltage is configured by a secondary battery such as a lithium ion battery or a nickel hydrogen battery, and outputs DC power having a high voltage of 250 V to 600 V or higher. The battery control device 184 outputs the charge/discharge status of the battery 180 and the state of each unit cell battery constituting the battery 180 to the integrated control device 170 via the communication line 174.

The integrated control device 170 is a higher-level control device than the transmission control device 134, the engine control device 124, the inverter device 600, and the battery control device 184. The integrated control device 170 receives information representing each state of the transmission control device 134, the engine control device 124, the inverter device 600, and the battery control device 184 via the communication line 174. The integrated control device 170 calculates a control command based on the acquired information. The calculated control command is transmitted to the devices 134, 124, 600, and 184 via the communication line 174.

The control command calculation of the integrated control device 170 will be described. When determining that the battery 180 needs to be charged based on the information from the battery control device 184, the integrated control device 170 instructs the inverter device 600 to perform the power generation operation. As a result, the battery 180 can acquire DC power from the inverter device 600 during regenerative traveling. The integrated control device 170 mainly manages output torque of the engine 120 and the motors 200 and 202, and performs calculation processing of a total torque and a torque distribution ratio between the output torque of the engine 120 and the output torque of the motors 200 and 202. A control command based on the calculation processing result is transmitted to the transmission control device 134, the engine control device 124, and the inverter device 600.

The inverter device 600 is provided with a power semiconductor constituting an inverter for operating the motors 200 and 202. Based on the torque command received from the integrated control device 170, the inverter device 600 controls the switching operation of the power semiconductor by a control unit provided therein so as to generate torque output or generated power according to the command. By the switching operation of the power semiconductor, the motors 200 and 202 are controlled to operate as an electric motor or a generator.

When the motors 200 and 202 are operated as an electric motor, DC power from the high-voltage battery 180 is supplied to the DC terminal of the inverter of the inverter device 600. The inverter device 600 converts the supplied DC power into three-phase AC power by controlling the switching operation of the power semiconductor and supplies the converted power to the motors 200 and 202. As a result, the motors 200 and 202 function as an electric motor.

On the other hand, when the motors 200 and 202 are operated as a generator, the rotors included in the motors 200 and 202 are rotationally driven by the rotational torque applied from the front wheel tire 110 during regenerative traveling. As a result, three-phase AC power is generated in the stator winding of the motors 200 and 202. The generated three-phase AC power is converted into DC power by the inverter device 600, and the DC power is supplied to the high-voltage battery 180, whereby the battery 180 is charged.

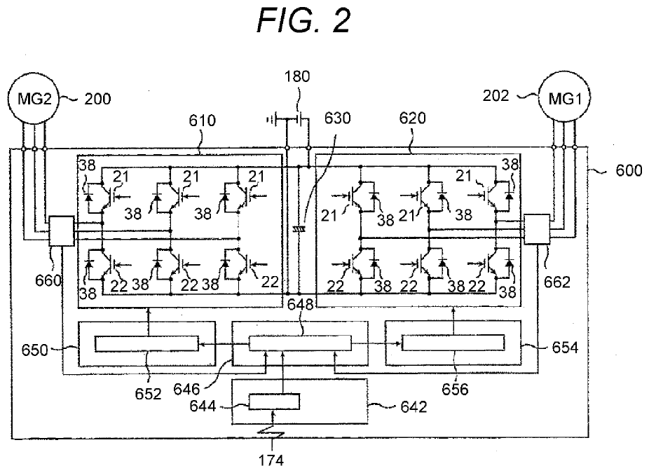

FIG. 2 is a circuit diagram of the inverter device 600 of FIG. 1.

A power module 610 of a first inverter device for operating the motor 200 and a power module 620 of a second inverter device for operating the motor 202 are connected to the inverter device 600 in a circuit.

Each of the power modules 610 and 620 converts DC power supplied from the battery 180 into three-phase AC power, and supplies the AC power to a stator winding which is an armature winding of the corresponding motors 200 and 202. During regenerative traveling, the power modules 610 and 620 convert AC power induced in the stator windings of the motors 200 and 202 into DC power and supplies the DC power to the battery 180.

The first inverter device includes the power module 610, the first drive circuit 652 that controls a switching operation of each power semiconductor 21 of the power module 610, and a current sensor 660 that detects a current of the motor 200. The drive circuit 652 is provided on a drive circuit board 650 related to the driving of the switching operation of the power module 610. The current sensor 660 that detects the three-phase AC power output from the power module 610 to the motor 200 may be provided in each of the three phases, or may be provided only in one phase as much as it can be controlled.

On the other hand, the second inverter device includes a power module 620, a second drive circuit 656 that controls the switching operation of each power semiconductor 21 in the power module 620, and a current sensor 662 that detects the current of the motor 202. The drive circuit 656 is provided on a drive circuit board 654 related to the driving of the switching operation of the power module 620. The current sensor 662 that detects the three-phase AC power output from the power module 620 to the motor 202 may be provided for each of the three phases, or may be provided for only one phase as much as it can be controlled.

The power modules 610 and 620 include three-phase bridge circuits, and series circuits corresponding to three phases are electrically connected in parallel between the positive electrode side and the negative electrode side of the battery 180. Each series circuit includes a power semiconductor 21 constituting an upper arm and a power semiconductor 22 constituting a lower arm.

In the present embodiment, an insulated gate bipolar transistor (IGBT) is used for the power semiconductors 21 and 22 as a switching power semiconductor element. The IGBT includes three electrodes of a collector electrode, an emitter electrode, and a gate electrode. A diode 38 is electrically connected between the collector electrode and the emitter electrode of the IGBT. The diode 38 includes two electrodes of a cathode electrode and an anode electrode. The cathode electrode is electrically connected to the collector electrode of the IGBT and the anode electrode is electrically connected to the emitter electrode of the IGBT so that the direction from the emitter electrode to the collector electrode of the IGBT is the forward direction.

As a switching power semiconductor element, a MOSFET (metal-oxide-semiconductor field-effect transistor) may be used for the power semiconductors 21 and 22. The MOSFET includes three electrodes of a drain electrode, a source electrode, and a gate electrode. In the case of the MOSFET, a parasitic diode in which a direction from the drain electrode to the source electrode is a forward direction is provided between the source electrode and the drain electrode. Therefore, it is not necessary to provide the diode 38.

The arm of each phase is configured by electrically connecting the emitter electrode of the IGBT and the collector electrode of the IGBT in series. In the present embodiment, in order to simplify the description, one IGBT of each of the upper and lower arms of each phase is illustrated as one power semiconductor, but since the current capacity to be controlled is large, a plurality of IGBTs are actually electrically connected in parallel.

In the example illustrated in FIG. 2, each of the upper and lower arms of each phase includes three IGBTs. The collector electrode of the IGBT 21 of each upper arm of each phase is electrically connected to the positive electrode side of the battery 180, and the source electrode of the IGBT 22 of each lower arm of each phase is electrically connected to the negative electrode side of the battery 180. The midpoint (the connection portion between the emitter electrode of the IGBT 21 on the upper arm side and the collector electrode of the IGBT 22 on the lower arm side) of each arm of each phase is electrically connected to the armature winding (stator winding) of the corresponding phase of the corresponding motors 200 and 202.

The control circuit 648 provided on the control circuit board 646, a capacitor module 630, and a transmission/reception circuit 644 mounted on a connector board 642 are circuits commonly used by the first inverter device and the second inverter device. The switching power semiconductor elements 21 and 22 described above operate via an input to the power modules 610 and 620 by a drive signal output from the corresponding drive circuits 652 and 656.

The drive circuits 652 and 656 constitute a drive unit for controlling the corresponding inverter devices 610 and 620, and generates a drive signal for driving the IGBT 21 on the basis of the control signal output from the control circuit 648. The drive signal generated by the drive circuits 652 and 656 is output to the gate of each power semiconductor element of the corresponding power modules 610 and 620. The drive circuits 652 and 656 is provided with six integrated circuits (IGBT) that generate drive signals to be supplied to the gates of the upper and lower arms of each phase, and the six integrated circuits are configured as one block.

The control circuit 648 is a control unit of each inverter devices 610 and 620, and includes a microcomputer that calculates a control signal (control value) for operating (turning on and off) the plurality of switching power semiconductor elements. That is, the inverter device 600 including the control circuit 648 serves as a motor control system. A torque command signal (torque command value) from the host control device, sensor outputs of the current sensors 660 and 662, and sensor outputs of rotation sensors (not illustrated) mounted on the motors 200 and 202 are input to the control circuit 648. The control circuit 648 calculates a control value based on these input signals, and outputs a control signal for controlling the switching timing of the power modules 610 and 620 to the drive circuits 652 and 656. The drive circuits 652 and 656 output the drive signals based on the control signal to the power modules 610 and 620.

The transmission/reception circuit 644 mounted on the connector board 642 is for electrically connecting the inverter device 600 and an external control device, and transmits and receives information to and from another device via the communication line 174. The capacitor module 630 constitutes a smoothing circuit for suppressing the fluctuation of the DC voltage caused by the switching operation of the IGBT 21, and is electrically connected in parallel to the terminals on the DC side in the first power module 610 and the second power module 620.

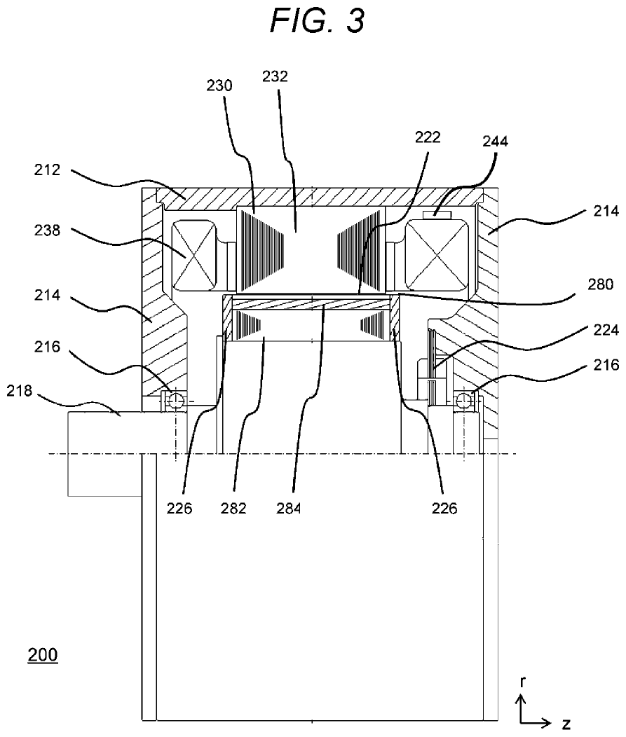

FIG. 3 is an r-Z cross-sectional view of the motor 200 of FIG. 1.

Although the motor 200 and the motor 202 have substantially the same structure, the following structure does not need to be adopted in both the motors 200 and 202, and may be adopted in only one of them. Hereinafter, the structure of the motor 200 will be described as a representative example.

A stator 230 is held inside the housing 212, and the stator 230 includes a stator core 232 and a stator winding 238. The stator winding 238 is a three-phase motor winding including a U-phase coil, a V-phase coil, and a W-phase coil.

In the radial direction with respect to a shaft 218, a rotor 280 is rotatably held on the inner peripheral side of the stator core 232 via a gap 222. The rotor 280 includes a rotor core 282 fixed to the shaft 218, a permanent magnet 284, and a non-magnetic contact plate 226.

The housing 212 has a pair of end brackets 214 provided with bearings 216, and the shaft 218 is rotatably held by these bearings 216. The shaft 218 is provided with a resolver 224 that detects a position and a rotation speed of a pole of the rotor 280. The output from the resolver 224 is taken into the control circuit 648 illustrated in FIG. 2.

As described above with reference to FIG. 2, the power module 610 performs a switching operation based on a control signal input from the control circuit 648, and converts DC power supplied from the battery 180 into three-phase AC power. The three-phase AC power is supplied to the stator winding 238 illustrated in FIG. 3, and a rotating magnetic field is generated in the stator 230. The frequency of the three-phase AC current is controlled based on the output value of the resolver 224, and the phase of the three-phase AC current with respect to the rotor 280 is also controlled based on the output value of the resolver 224.

The motor 200 is provided with a protection function so that each component does not exceed a heat-resistant temperature. Examples of the protection method include a method of monitoring and protecting an actual temperature by a thermistor 244 which is a temperature sensor, and a method of monitoring and protecting an estimated temperature by temperature estimation calculation incorporating a thermal circuit and the like described later.

In the method of protection by the thermistor 244, the thermistor 244 is directly attached to the component to be protected to monitor the actual temperature. The thermistor 244 may be attached one by one to three phases of the U-phase, the V-phase, and the W-phase of the stator winding 238 having a large calorific value to measure the temperature of the coil, or may be attached one by one to two phases to measure the temperature. In consideration of simplification of control in terms of cost and layout, the temperature of the coil may be measured by attaching the thermistor 244 to only one phase of the stator winding 238 which is likely to be the maximum temperature portion, or may be measured by attaching a plurality of thermistors to one phase. Among them, when the star connection is used for the connection method of the stator winding 238, the temperature of the coil may be measured by being attached to a neutral point, or if the temperature of each component can be protected, a plurality of components other than the stator winding 238 may be attached and measured without any problem. In the description of the present invention, it is assumed that only one thermistor 244 is attached to the V-phase to protect the motor.

Since the stator winding 238 has a temperature gradient in the component, as long as the layout inside the motor 200 is allowed, mounting the thermistor 244 on a portion where the temperature is high enables more accurate protection. A method of monitoring and protecting an estimated temperature by a temperature estimation calculation incorporating the thermal circuit and the like will be described later.

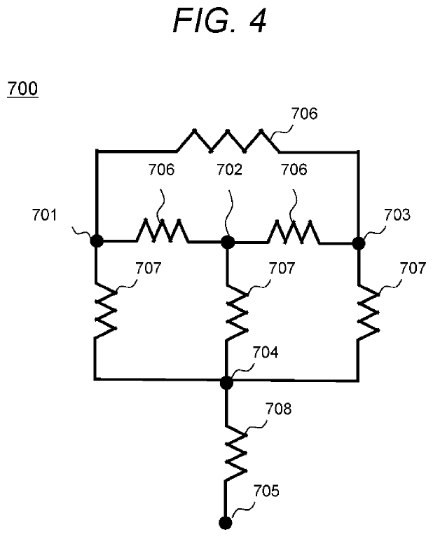

FIG. 4 is a schematic diagram of a thermal circuit used in a method of monitoring and protecting an estimated temperature by a temperature estimation calculation.

In the calculation of the temperature estimation value of the control circuit 648, the calorific value is calculated using the current values read by the current sensors 660 and 662 of the inverter device 600. That is, the control circuit 648 is a coil temperature estimation unit that inputs a calorific value to each node of a thermal circuit 700 based on the value of the current flowing through a three-phase motor winding 238, and estimates and calculates the temperatures of the U-phase, V-phase, and W-phase stator windings 238 and the stator core 232 based on the heat capacities set in thermal resistors 706, 707, and 708 and nodes 701, 702, 703, and 704.

A configuration of the thermal circuit 700 will be described. The thermal circuit 700 is a thermal circuit including a U-phase winding node 701, a V-phase winding node 702, a W-phase winding node 703, a stator core node 704, a cooling source node 705, a thermal resistor 706 in the winding connecting the windings of the U-phase winding node 701, the V-phase winding node 702, and the W-phase winding node 703, a thermal resistor 707 between the wounding and the stator core connecting each of the phase winding nodes 701, 702, and 703 and the stator core node 704, and a thermal resistor 708 between the stator core and the cooling source connecting the stator core node 704 and the cooling source node 705.

In the present embodiment, the thermal circuit 700 is a water-cooling type thermal circuit in which a water passage is provided in a housing. Therefore, the thermal circuit 700 is configured such that the cooling source node 705 is connected to the stator core node 704. When the oil cooling system for directly cooling the stator winding is used, the cooling source node 705 may be set to be connected to the winding nodes 701 to 703 and the stator core node 704 of each phase. When a cooling source other than water cooling and oil cooling is used, similar calculation can be performed by setting the cooling source node 705 corresponding to the thermal circuit 700.

In the present embodiment, the number of nodes to be calculated is suppressed to the utmost in order to suppress the control load as much as possible. However, if there is control capacity margin, the winding nodes 701 to 703 and the stator core node 704 may be further divided, or a component node other than the winding nodes 701 to 703 and the stator core node 704 may be added in order to improve accuracy, or if there is another component to be protected, a node may be added and expanded each time. However, since in terms of control the capacity increases as the number of items to be calculated increases, it is desirable to set the number of nodes to be protected to the minimum necessary.

The temperature estimation calculation using the thermal circuit 700 will be described. Here, the motor 200 will be described as a representative example. The calorific value of the motor 200 has the same meaning as a loss that is a value obtained by subtracting the output of the motor 200 from the input of the motor 200 (calorific value of the motor 200=loss of the motor 200). As the loss set in the thermal circuit 700, a loss map including the torque and the rotation speed is used. As a result, it is possible to use a method of calling the map from the torque command from the host control device or the rotation speed read by the resolver 224, or a method of calculating using the current value read from the current sensor 660 attached to the inverter device 600.

When the loss map is used, a loss value obtained from calculation such as magnetic field analysis may be used, or a measured loss may be set. The loss map has an advantage that the loss of each part can be separated when calculation such as magnetic field analysis is used, but has a disadvantage that a difference from actual measurement may be generated. In a case where actual measurement is used, there is an advantage that a loss actually occurring can be used, but there is a disadvantage that only a copper loss occurring in the stator winding 238 and other losses can be separated from values that can be read from various sensors.

Therefore, it is preferable to calculate the loss of each part by bringing the advantages of both. For example, loss separation may be performed by applying a calculated loss ratio to actual measurement, or calculation may be performed only by calculation by matching calculation based on an actual measurement result. Since the former using actual measurement uses actual measurement values, higher accuracy can be desired.

When the current value read from the current sensor 660 attached to the inverter device 600 is used, the value read from the current sensor 660 may be applied as it is, or a value obtained by mean square or root mean square of the accumulated current values may be used. In a case where the current sensor 660 is attached to only one phase or two phases, since the electrical phase difference of the three phases of the stator winding is 120°, it is possible to estimate and calculate the current value of the other phase to which the current sensor 660 is not attached based on the angle information of the resolver 224.

The value of the current sensor 660 may not be used as it is, and may be allocated to three phases based on the command value or the actual value of the d-axis current and the q-axis current subjected to the two-phase-three-phase conversion used in the control of the motors 200 and 202 and the angle information of the resolver 224. The value of the copper loss is calculated from the current value thus acquired and the resistance value of the stator winding 238.

For the other losses such as iron loss, a map in which only the other losses such as iron loss in the above-described loss map may be provided, or the thermal resistance may be set to be large in consideration of the other losses such as iron loss. A mathematical expression for the current may be simply incorporated, or if the region in which the temperature estimation calculation is performed is only a low rotation region in which a loss such as an iron loss is small, only a copper loss may be taken into consideration. The estimation calculation can be performed with high accuracy in consideration of a loss such as an iron loss, but it is desirable to select in consideration of a control load.

The heat capacity set in each of the thermal resistors 706, 707, and 708 and each of the nodes 701, 702, 703, and 704 may be set by calculation from physical property values such as density, thermal conductivity, and specific heat of the component, may be used by actually measured thermal resistance and heat capacity, or may be set to a value adjusted based on an actually measured temperature. However, it is difficult to calculate all the heat capacities by calculation with respect to the amount of varnish fixing the stator winding 238 and the stator core 232 with which it is difficult to grasp the actual degree of penetration. Therefore, higher accuracy can be expected when a value adjusted to the calculation based on actual measurement is set. In the case of matching between actual measurement and calculation, any value does not matter depending on the temperature protection or the time desired to operate until torque limit is applied at the same operating point. For example, when the calculated value is adjusted so as to have the same temperature as that of the thermistor 244, there is an advantage that a satisfactory result is likely to be obtained because a temperature level difference cannot be formed due to the switching when the protection by the thermistor 244 and the protection by the temperature estimation calculation are combined.

Regarding the temperature calculation of each node, the temperatures of the winding nodes 701, 702, and 703 and the stator core node 704 are calculated, but the temperature of the cooling source node 705 may be, for example, a temperature measured by a pump that circulates long life coolant (LLC) that is cooling water, a temperature of a water temperature sensor attached to a motor or an inverter device, a water temperature estimated from a temperature sensor attached for temperature protection of a power module, or may be fixed at any value as long as it can be protected in the case of a water cooling system in which a water passage is provided in a housing. However, in this case as well, similarly to the method described above, it is desirable to use a temperature that achieves an actual water temperature as much as possible in order to prevent overprotection. Similarly, in the case of the oil-cooling system by automatic transmission fluid (ATF), if there is a circulation device, a temperature sensor may be attached to the circulation device, or a temperature sensor may be attached to the inside of the motor 200, or a fixed value may be used. In other cooling systems, a temperature sensor may be similarly used, or a thermal circuit may be incorporated with a fixed value.

Although it is possible to obtain better accuracy by using a value obtained by directly measuring the temperature in the temperature calculation of each node, it is desirable to estimate the temperature from a fixed value or another temperature sensor if there is reserve as an overheat protection function because it is trade-off with layout and cost.

It is more accurate to shorten the cycle of the temperature estimation calculation as much as possible if there is no problem in the control. However, in a case where the frequency (cycle) of the rotation of the motor 200 and the calculation cycle are synchronized with each other, the cycle becomes equal to a state where the motor is not rotating in a pseudo manner, which may cause malfunction. Therefore, in order to configure the shape of the sinusoidal current flowing through the stator winding 238 of the motor 200, it is desirable to set the cycle such that the calculation can be performed 5 times or more in one electrical cycle at the maximum rotation speed of the range in which the temperature estimation calculation is performed.

As another method of estimating the temperature, a method of estimating the winding wire temperature by monitoring the LLC temperature in the case of water cooling and monitoring the ATF temperature in the case of oil cooling using the ATF without assembling the thermal circuit 700 can also be adopted. However, since the temperature is not directly estimated, it is necessary to set the temperature rather than overprotection.

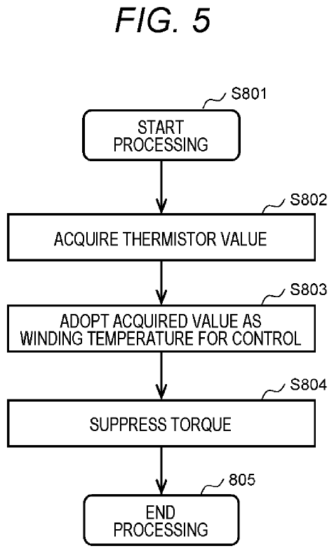

FIG. 5 is a flowchart of a conventional technique in which only a thermistor is used for temperature protection.

In Step S801, the processing is started when the power supply of the inverter device 600 is turned on. The thermistor value is acquired at the time interval set in the control circuit 648 of the inverter device 600 in Step S802.

The thermistor value acquired in Step S803 is adopted as a winding wire temperature used for a control protection function incorporated in the inverter device 600. In Step S804, when the value of the winding wire temperature exceeds the torque limit threshold, the control circuit 648 controls the power conversion device 600 so as to suppress the torque to a protectable range and not to exceed the heat-resistant temperature of the stator winding 238. The processing ends in Step S805, but this processing continues as long as the power supply of the inverter device 600 is on.

Since the heat generation of the stator winding 238 is proportional to the square of the three-phase alternating current, and the three-phase alternating current and the torque are in a proportional relationship, when the torque limit threshold is exceeded, the temperature of the stator winding 238 is often lowered and protected by lowering the torque command to a torque that can be continuously operated. The torque command change rate is preferably set in consideration of the heat-resistant temperature and the behavior of the vehicle.

In the prior art, when only the thermistor 244 is used, it is advantageous that protection can be applied using an actual temperature, but as a problem, when only one thermistor 244 is attached and only one of three phases is attached due to layout restriction, protection is difficult.

The flowchart illustrated in FIG. 5 can also be applied to the case of only protection by temperature estimation. In this case, the flowchart of the processing is similar to the flowchart of FIG. 5 except that the acquisition of the thermistor value is temperature estimation calculation. The determination to suppress the torque command in the temperature estimation calculation is similar to the protection by the thermistor 244, and when any of the temperature estimation values of the three phases exceeds the torque limit threshold, the torque command is suppressed and control is performed so as not to exceed the heat-resistant temperature.

The protection method by temperature estimation is effective when the thermistor 244 is attached to only one phase and is not rotating (when the temperature of the three-phase winding is biased) since each of the three phases can be calculated. However, since an error of the current sensor or the like is included, there is a possibility that the protection cannot be performed unless overprotection measures such as reducing the output of the motors 200 and 202 are taken in consideration of the error. By doing so, the output of the motors 200 and 202 is also adversely affected.

Here, since both the protection by the thermistor 244 and the protection by the temperature estimation calculation have advantages, it is a gist of the present invention to solve the problem by applying two protection methods without being limited to either one. As a result, it is possible to perform an operation that does not become overprotection in a wider output range than the conventional case.

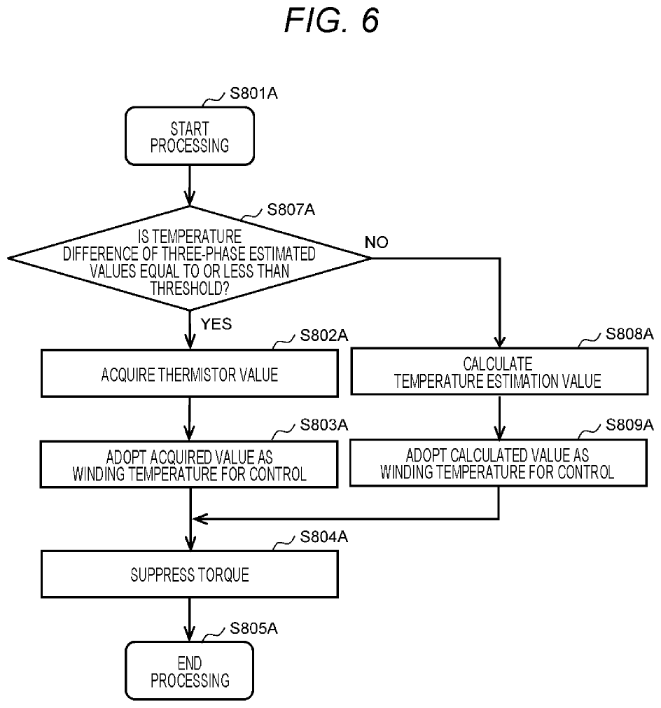

FIG. 6 is a flowchart in a case where the protection by the thermistor and the protection by the temperature estimation calculation are combined, and the temperature difference of the three-phase estimated value is used to determine the switching.

The processing is started when the inverter device 600 is powered on in S801A. First, in Step S807A, an estimated value of the phase winding is acquired, and it is confirmed whether the temperature difference is within a predetermined temperature, that is, equal to or less than a predetermined threshold. The initial value of the acquired estimated value of the phase winding is the temperature detected by the thermistor 244 at this time. When the estimated value is equal to or less than the threshold, the value of the thermistor 244 is acquired again in Step S802A as protection by the thermistor 244, and the value is adopted as the control winding wire temperature in Step S803A.

In the present embodiment, the initial value of the estimated value when the temperature estimation calculation is turned on is set as the temperature of the thermistor 244, but a method may be used in which the estimation calculation is performed in the background even during the protection period by the thermistor 244, and the determination of the temperature to which the torque limit is applied is switched from the detected value to the estimated value when the protection method is switched. In this case, since there is a possibility that sensor errors accumulate in the temperature estimation calculation, it is desirable to reset the temperature so as to return to the thermistor temperature 760 in a certain period of time in order to improve accuracy.

On the other hand, when the temperature is equal to or greater than the threshold in Step S807A, the temperature estimation value is calculated in Step S808A as protection by the temperature estimation calculation, and the calculated value is adopted as the winding wire temperature for control in Step S809A. The control circuit 648 determines whether the protection is necessary based on the value of the adopted winding wire temperature, and when the value exceeds the torque limit threshold, suppresses the torque in Step S804A to perform temperature protection. As long as the inverter device 600 is powered on, this series of processing continues to be performed.

By using the two protection methods by switching between the predetermined thresholds in this manner, it is possible to utilize the advantages of the respective protection methods, and in a case where the thermistor 244 is attached to only one or two of the three phases, it is possible to perform protection even when there is a temperature difference among the three phases of the stator winding 238.

Even in a case where the thermistor 244 is provided with three phases, the calorific value when the motor 200 is stopped (0 r/min) is twice as large as that at the time of rotation (the current peak is √2 times the effective value, and the copper loss is RI\hat{ }2) at the maximum. Therefore, in a case where protection is performed only with the thermistor 244 having a time constant, it is necessary to have more power than that at the time of rotation. However, in the temperature estimation calculation, the time constant may or may not be provided. That is, since the time constant can be arbitrarily set in the temperature estimation calculation, even if three thermistors 244 are attached, the reserve power can be reduced by using the temperature estimation calculation at an extremely low speed, and higher performance than temperature protection by only the thermistor 244 in the related art can be provided.

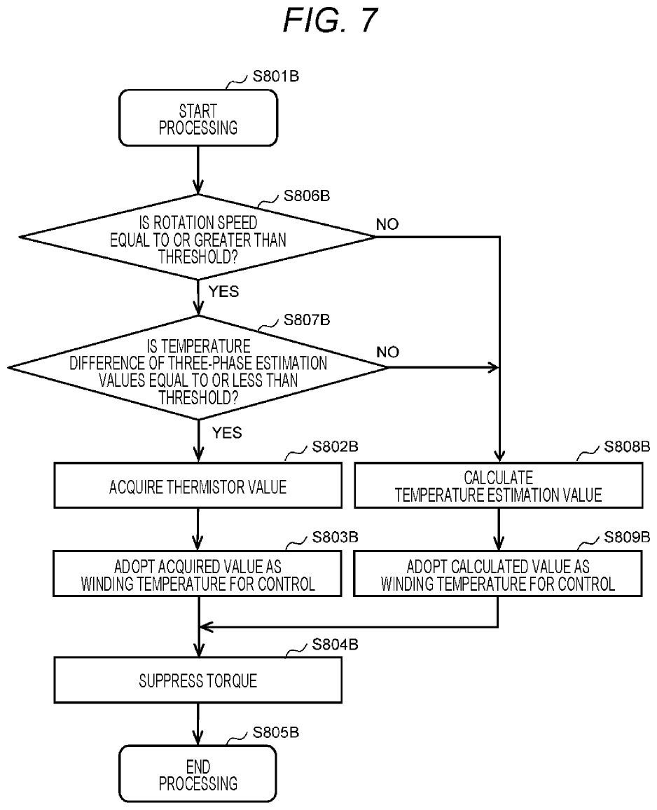

FIG. 7 is a flowchart in a case where the protection by the thermistor and the protection by the temperature estimation calculation are combined, and a threshold of the rotation speed is added.

When the power of the inverter device 600 is turned on in Step S801B, the processing is started. In Step S806B, the rotation speeds of the motors 200 and 202 are read from the resolver 224, and whether the read rotation speed is equal to or greater than a predetermined threshold is determined. In Step S806B, when the rotation speed is equal to or less than the threshold, the protection by the coil temperature estimation value is started. That is, the process proceeds to Step S808B, the temperature estimation value is acquired, the value is adopted as the winding wire temperature for control, and the temperature estimation calculation is performed. Whether protection is necessary is determined based on the value of the winding wire temperature adopted in Step S804B. When the value exceeds the torque limit threshold, temperature protection is performed by suppressing the torque. The processing is completed in Step 805B, but this processing continues as long as the inverter device 600 is powered on. In this flowchart, when the rotation speed is equal to or greater than the threshold in Step S806B, the flow after Step S807B is the same as the flowchart of FIG. 7.

In this way, by providing the threshold of the rotation speed, it is possible to facilitate region division between protection by the thermistor 244 and protection by temperature estimation calculation. For example, by setting the initial value to the thermistor temperature at the time of switching to the temperature estimation calculation, an error factor (current sensor error or the like) of the temperature estimation calculation can be minimized, and overheat protection can be performed with higher accuracy.

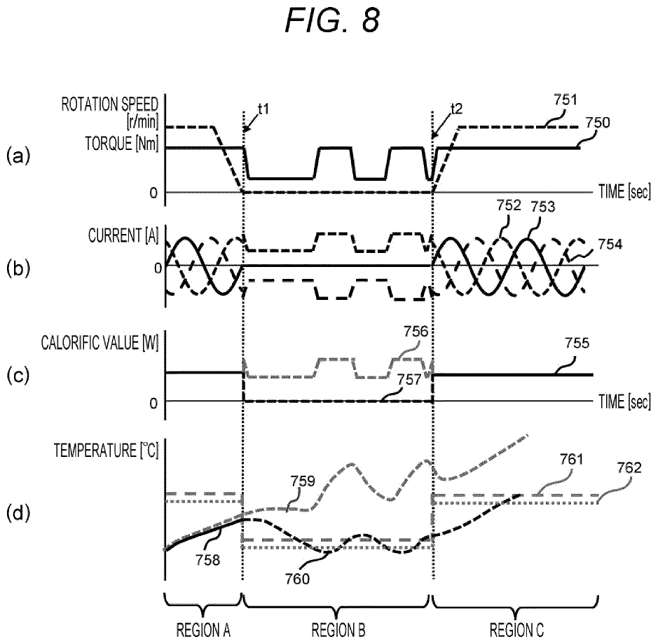

FIG. 8 is a schematic diagram of an operation in a case where only a thermistor is used as a temperature protection function and the thermistor is attached to the V-phase winding.

It is verified whether temperature protection is possible even when the thermistor 244 is attached to only one phase. The thermistor 244 is attached to the V-phase coil of the coil end on the open side, but as described above, when the rotation of the motors 200 and 202 is 0 rpm, a temperature difference occurs in the three phases due to the bias of the three-phase current, and there is a possibility that the thermistor cannot be protected.

For example, in this case, although the temperatures of the three phases are in an unbalanced state, it is possible to take a measure by lowering the threshold of the torque limit ON than that at the time of rotation so as to be able to protect the three phases. When the rotation speed reaches 0 rpm, the torque exceeds the torque limit ON threshold, and thus the torque is limited. However, since the three-phase temperature remains unchanged and is in an unbalanced state when the rotation starts again, the temperature at which the torque limit is applied may exceed the control temperature that can be protected.

More specifically, control using only a thermistor as a temperature protection function will be described with reference to FIGS. 8(a) to 8(d). FIGS. 8(a) to 8(d) illustrate a state of operating at the same time.

FIG. 8(a) illustrates behaviors of the torque 750 and the rotation speed 751. Here, the torque command is constant (Excluding the range until the winding wire temperature exceeds a torque limit ON threshold 761 and falls below a torque limit OFF threshold 762 in FIG. 8(d) to be described later). Time t1 is the time at the boundary at which the motors 200 and 202 shifts from rotation to stop, and Time t2 is the time at the boundary at which the motors 200 and 202 shifts from stop to rotation. Regarding the rotation of the motors 200 and 202, the rotation speed gradually decreases from the rotation state in the region A, so that the rotation is stopped in the region B. Then, in the region C, the operation of returning the rotation state from the stop state to the original rotation speed by rotating again is illustrated.

FIG. 8(b) illustrates the current of the three-phase winding during the operation of FIG. 8(a). In the regions A and C in the rotating state, a U-phase current 752, a V-phase current 753, and a W-phase current 754 flow in a sinusoidal shape with an electrical phase difference of 120°, and in the region B, the rotation stops when the V-phase current 753 attached to the thermistor 244 becomes 0 A, and the rotation starts again in the region C and returns to a state in which a sinusoidal current flows. Note that the frequency of the current changes according to the rotation speed 751, but in FIG. 8(b), a detailed frequency change according to the rotation speed 751 is omitted so that the state when the motor is rotating and the state when the motor is stopped can be understood.

FIG. 8(c) illustrates a calorific value (copper loss). FIG. 8(c) illustrates a copper loss 755 of the winding during rotation, a copper loss 756 of the U-phase and W-phase windings during stop, and a copper loss 757 of the V-phase winding during stop. In this graph, the calorific value at the current peak is assumed to be 100 W.

Since the value of the copper loss is determined by the winding resistance and the square of the current, for example, when the calorific value at the peak of the sine wave is 100 W, the current in the regions A and C during rotation is 50 W in consideration of the effective value of the sine wave.

Since the current value is fixed according to the current phase at the moment when the region B is stopped, the calorific value differs for each winding. In the case of FIG. 8(c), when the current value of the V-phase is 0 A, the current values of the U-phase and the W-phase are the same, and in this phase, the U and W-phase windings 756 are 75 W (torque is limited so as to temporarily become 45 W at the time of overheat protection). Although the V-phase winding 757 is 0 W, since the U-phase, V-phase, and W-phase windings are in a mechanically close positional relationship, the temperature rises due to heat transfer between the phases.

FIG. 8(d) illustrates how the temperature of the U-phase, V-phase, and W-phase windings rises due to the stop of the rotation of the motor, the torque limit ON threshold 761, and the torque limit OFF threshold 762. In FIG. 8(d), in a stop region B where a difference in the calorific value occurs between the temperature 759 of the U-phase winding and the W-phase winding and the temperature 760 of the V-phase winding, the torque limit ON threshold 761 and the torque limit OFF threshold 762 are lower than those in the regions A and C so that the three-phase temperature can be protected even in an unbalanced state.

As illustrated in FIG. 8(d), the temperature of the U-phase and the W-phase does not exceed the torque limit ON threshold 761 and the torque limit OFF threshold 762 due to the difference in the calorific value in the state where the rotation of the motors 200 and 202 is stopped in the region B. Therefore, there is a difference between the temperature of the U-phase W-phase and the temperature of the V-phase.

torque limit is applied when the temperature 760 of the thermistor 244 attached to the V-phase winding being monitored exceeds the torque limit ON threshold 761, and the torque limit is released and returns to the original torque command when the temperature falls below the torque limit OFF threshold 762.

Regarding the temperature rise of each phase in the region A, since the calorific values of the U-phase, the V-phase, and the W-phase are the same, the temperatures (during rotation) 758 of the windings are the same for all the three phases. However, in the region B, since the torque limit ON threshold 761 changes in response to the rotation speed becoming 0/min, the torque is limited at the same time as the region B is entered. As a result, the torque limit ON and OFF are repeated between the regions B.

When the motors 200 and 202 enters the region C and starts to rotate again, the torque limit ON threshold 761 and the torque limit OFF threshold 762 return to the thresholds at the time of rotation of the region A. Therefore, the torque limit is turned OFF while maintaining the temperature difference of the three-phase windings.

However, in this way, the torque limit is turned off while the temperature 760 of the V-phase winding is low and the temperature 759 of the U-phase W-phase winding has a high temperature difference during the rotation of the region C. Therefore, when the temperature of the V-phase winding to which the thermistor is attached is a temperature that reaches the torque limit ON threshold 761, the temperature 759 of the U-phase and W-phase windings may exceed the heat-resistant temperature. That is, when the rotation starts again, the temperatures of the three phases are in an unbalanced state.

Therefore, in the region C, the rotation of the motor is started while the difference between the temperatures of the U-phase and W-phase and the temperature of the V-phase cannot be eliminated, and there is a possibility that the temperature exceeds the control temperature at the subsequent temperature at which the torque is limited. Therefore, there is a possibility that the protection cannot be performed when the thermistor 244 is attached to only one phase.

As described above, in a case where the torque limit ON threshold and the torque limit OFF threshold are separated at the time of rotation and at the time of stop, protection can be performed only by each operation, but protection becomes difficult when the operation is performed with a complicated profile in which rotation and stop are repeated. Such switching of the threshold is not preferable because torque fluctuation occurs when the torque limit is turned off at the moment when the threshold is switched, resulting in unstable operation.

As another method, there is a method in which a torque limit ON threshold or a torque limit OFF threshold is not provided at the time of stopping, a torque limit is applied when an arbitrary number of seconds is exceeded using a timer from the time of stopping, and the torque limit is turned OFF when the arbitrary number of seconds is limited. However, in this case, since the temperature change varies depending on the commanded torque, the time of the timer needs to be increased in order to be able to be protected at any time, and thus an overprotection design is necessarily made.

As other methods, a method of attaching at least one thermistor 244 for each phase so as to facilitate protection, and a method of attaching the thermistor 244 to a neutral line coil in which three phases are electrically connected can be considered. However, when a plurality of thermistors 244 is provided as described above, there is a concern that the cost layout becomes large.

Attachment of the thermistor 244 to the neutral line is a place where three phases are electrically connected to each other in the neutral line, and a burden at the time of layout of attachment of the thermistor 244 is reduced as compared with the above-described method. However, there is a problem that a torque limit threshold is set so as to be overprotected since there is a mechanical distance and the temperature of a phase having a high temperature may not be accurately grasped considering thermal conduction of a component.

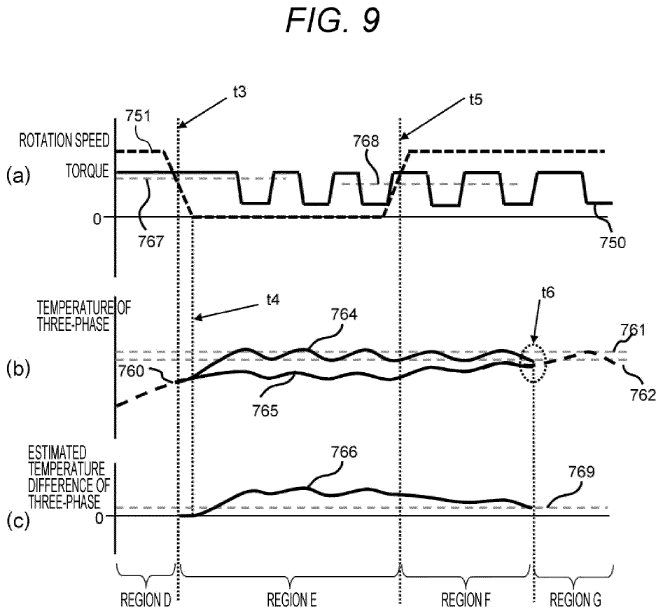

FIG. 9 is an operation schematic view when protection by a thermistor and protection by temperature estimation calculation according to an embodiment of the present invention are combined.

FIG. 9(a) illustrates the transition of the torque 750 and the rotation speed 751. Note that FIG. 9(a) is not intended only for the flowchart of FIG. 6, but is also intended to select the protection method by the rotation speed in the determination of Step S806B of FIG. 7, and thus, a temperature estimation ON threshold (rotation speed) 767 and a temperature estimation OFF threshold (rotation speed) 768 are also illustrated.

FIG. 9(b) illustrates the transition of the U and W-phase winding wire temperature estimation values 764 and the V-phase winding wire temperature estimation value 765 with the transition of the torque 750 and the rotation speed 751 in FIG. 9(a), and illustrates the torque limit ON threshold 761 and the torque limit OFF threshold 762.

FIG. 9(c) illustrates a three-phase estimated value temperature difference 766 based on FIG. 9(b) and a temperature estimation OFF threshold (three-phase estimated value temperature difference) 769. In the present embodiment, each thermal resistance and heat capacity of the temperature estimation calculation are operated in a case where the thermistor temperature 752 and the three-phase estimated value are adjusted to be equal to each other.

FIGS. 9(a) to 9(c) will be described with reference to the flowchart of FIG. 7. In a region D of FIG. 9(a), the temperature estimation calculation is in a state of the rotation speed 751 higher than the ON threshold (rotation speed) 767, and the protection to be described later is determined based on the temperature read from the thermistor 244 in this state. In this range, the thermistor temperature 760 does not reach the torque limit ON threshold 761 as illustrated in FIG. 9(b), and thus torque limit is not applied.

The control circuit 648 that starts the temperature estimation calculation in FIG. 9(a) uses the temperature estimation calculation ON threshold (rotation speed) 767 to determine the protection method based on whether the motor rotation speed read from the resolver 224 is equal to or less than this threshold. When the motor rotation speed becomes equal to or less than the predetermined motor rotation speed at time t3, as shown in Step S806B of FIG. 7, the protection using the thermistor 244 is switched to the protection by the temperature estimation calculation.

In the region E, the temperature estimation calculation is started, and the temperature estimation values of the three phases transition at the same temperature during rotation. When the rotation becomes 0 r/min, there is a difference in the current values of the three phases (a difference in the calorific value). Therefore, in the operation in a case where the rotation speed 751 becomes 0 r/min at the rotation angle at which the V-phase in FIG. 9(a) becomes 0 A at time t4, the temperature of the V-phase winding is less likely to increase as illustrated in FIG. 9(b), and the gradient of the temperature rise of the U-phase winding and the W-phase winding becomes larger than that at the time of rotation. In the temperature estimation calculation, since the torque limit is applied when the torque limit ON threshold 761 is exceeded even with the temperature estimation value of any of the three-phase windings, the operation of applying the torque limit with the U-phase and W-phase winding wire temperature estimation values 764 is performed. In FIG. 9(c) illustrating the temperature difference between the V-phase and the U and W-phases at this time, the value of the three-phase estimated value temperature difference 766 also greatly changes according to the difference in calorific value.

The rotation starts again at time t5, and the rotation speed 751 exceeds the temperature estimation OFF threshold (rotation speed) 768 in the region F, but as can be seen from FIG. 9(c), the three-phase estimated value temperature difference 766 is larger than the temperature estimation value OFF threshold (three-phase temperature estimation value temperature difference) 769. Therefore, the protection by the temperature estimation calculation is continued without switching the protection.

At time t6, the three-phase estimated value temperature difference 766 is equal to or less than the temperature estimation value OFF threshold (three-phase temperature estimation value temperature difference) 769. As a result, two temperature estimation OFF thresholds of the rotation speed and the three-phase temperature estimation value temperature difference are satisfied, and the temperature difference of the three-phase estimated values is within the predetermined temperature. Therefore, at time t6, the protection by the temperature estimation is switched to the protection by the thermistor 244. As illustrated in FIG. 9(b), the behavior of the region G is performed thereafter. Thereafter, when the rotation speed 751 falls below the temperature estimation ON threshold (rotation speed) 767 again, that is, falls below a predetermined rotation speed, the protection method is switched from the thermistor 244 to temperature estimation, and the protection method of the temperature estimation calculation by the temperature estimation control is performed again.

The present invention is capable of overheat protection even when there is a difference in temperature rise. Since the thermistor 244 monitors only the V-phase temperature, it is difficult to protect against stall. Temperature protection is performed by performing temperature estimation for three phases of a U-phase, a V-phase, and a W-phase by the thermal circuit 700 instead of the thermistor 244. In the present invention, the temperature of each component is estimated by the thermal circuit 700 for temperature estimation, and the heat capacity and the heat resistance are adjusted to match the actual temperature. Then, the temperature estimation is switched to the temperature measurement of the thermistor 244 when the temperature difference of the estimated values of the three phases falls within a predetermined temperature.

That is, the temperature estimation control is protected by the thermistor 244 in the region of the predetermined rotation speed or more, and when the temperature difference of the estimated values of the three phases is within a predetermined temperature difference, the temperature estimation control is continued, and the protection can be performed even after the rotation is started again. Since the temperature estimation calculates the temperatures of the three phases, the motors 200 and 202 can be protected without changing the torque limit ON threshold as illustrated in FIG. 8(c).

Alternatively, the thresholds of the temperature estimation ON/OFF may be set to only the temperature estimation value temperature difference. The thermistor temperature and the temperature estimation value may be constantly monitored. When there is no three-phase temperature difference in the temperature estimation value, the torque limit ON/OFF may be determined based on the thermistor temperature. When the three-phase temperature difference in the temperature estimation value starts to appear, the torque limit ON/OFF may be determined based on the temperature estimation value. In this case, as described above, the temperature transition is the same as the thermistor temperature at the time of rotation, and the temperature estimation value is reset to the value of the thermistor temperature at a certain cycle in consideration of an error in the temperature estimation calculation, whereby better accuracy can be maintained.

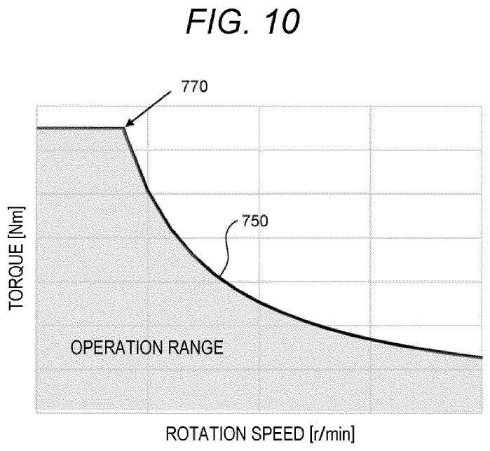

FIG. 10 is a diagram illustrating a torque rotation speed characteristic of the motor.

In general, when the vehicle desires to apply a rotational force in the traveling direction, control is performed such that battery voltage>motor voltage, and adjustment is performed such that current flows through the motor. Since the voltage of the motor is proportional to the rotation speed, field weakening control is performed so as not to exceed the battery voltage.

Regarding the threshold for switching between the protection by the thermistor 244 and the protection by the temperature estimation calculation, it is desirable that the temperature estimation ON threshold (rotation speed) 767 and the temperature estimation OFF threshold (rotation speed) 768 illustrated in FIG. 9(a) are set to values larger than the rotation speed reading error of the resolver 224 because switching of the protection method is not frequently performed when the resolver operates near the threshold. Although the accuracy varies depending on the configuration of the thermal circuit 700 used for the temperature estimation calculation in FIG. 4, in the low rotation region where the copper loss is dominant among the calorific values of the motor, good accuracy can be easily maintained even with a simple thermal circuit. Therefore, when the load in terms of control is reduced, the rotation speed threshold is desirably low.

For example, when the base rotation speed 770 at which the rotation speed is the highest among the maximum torques is set, in consideration of the fact that the copper loss increases as the torque increases and the iron loss increases as the rotation speed increases, the determination threshold that allows the vehicle to exit from the temperature estimation calculation even at a speed of 10 to 20 km/h in a traffic jam may be set to be equal to or less than the rotation speed of the motor or equal to or less than the torque value.

It is desirable to set the threshold of the three-phase estimated value temperature difference as small as possible based on an error of a current sensor used for calculation and an error of temperature estimation calculation because an error with a thermistor at the time of switching is reduced.

As described above, by providing the rotation speed and the temperature difference of the three-phase estimated value as the switching method, it is possible to protect even if only one phase is attached to the thermistor 244. Even in a case where the thermistors 244 are attached to three phases one by one, temperature protection can be performed with higher accuracy at the time of stopping.

As described above, the present embodiment is an example of the interior permanent magnet type motors 200 and 202 in which the magnet is embedded in the rotor. However, the present invention is not limited to this, and a protective function applicable to any motor that requires temperature protection, such as a surface permanent magnet type motor attached to the surface of the rotor, a motor using only a reluctance torque due to the structure of the rotor that does not use a permanent magnet, and an induction machine.

According to the embodiment of the present invention described above, the following operational advantages are achieved.

(1) A motor control system 600 controls a motor 200 (202) including a three-phase motor winding 238 including a U-phase coil, a V-phase coil, and a W-phase coil, and a thermistor 244 that measures a temperature of any one or two of the coils of the three-phase motor winding 238. The motor control system includes: a coil temperature estimation unit (control circuit 648) that calculates an estimated temperature of each of the U-phase coil, the V-phase coil, and the W-phase coil based on a value of a current flowing through the three-phase motor winding 238. The motor 200 (202) is controlled based on the estimated temperature of the three-phase motor winding 238 when a difference between the estimated temperatures of the three-phase motor winding 238 is larger than a predetermined value. The motor 200 (202) is controlled based on a measured value of the thermistor 244 when a difference between the estimated temperatures of the three-phase motor winding 238 is equal to or less than the predetermined value. With this configuration, it is possible to provide a motor control system that enables three-phase overheat protection without providing sensors in all of the U-phase, the V-phase, and the W-phase of a motor.

(2) The motor 200 (202) is controlled based on the measured value of the thermistor 244 when the difference between the estimated temperatures of the three-phase motor winding 238 of the motor control system 600 is equal to or less than the predetermined value and a rotation speed of the motor 200 (202) is equal to or greater than a predetermined rotation speed. With this configuration, it is possible to facilitate region division between protection by the thermistor 244 and protection by temperature estimation calculation.

(3) When the rotation speed of the motor 200 (202) is less than the predetermined rotation speed, the motor control system 600 controls the motor 200 (202) based on the estimated temperatures of the three-phase motor winding 238 even if the difference between the estimated temperatures of the three-phase motor winding 238 is equal to or less than the predetermined value. With this configuration, it is possible to facilitate region division between protection by the thermistor 244 and protection by temperature estimation calculation.

(4) A method of controlling a motor including a three-phase motor winding 238 including a U-phase coil, a V-phase coil, and a W-phase coil, and a thermistor 244 that measures a temperature of any one or two of the coils of the three-phase motor winding 238, the motor control method including: calculating an estimated temperature of each of the U-phase coil, the V-phase coil, and the W-phase coil based on a value of a current flowing through the three-phase motor winding 238; controlling the motor 200 (202) based on the estimated temperature of the three-phase motor winding 238 when a difference between the estimated temperatures of the three-phase motor winding 238 is larger than a predetermined value; and controlling the motor 200 (202) based on a measured value of the thermistor 244 when a difference between the estimated temperatures of the three-phase motor winding 238 is equal to or less than the predetermined value. With this configuration, the motor control system can achieve three-phase overheat protection without providing sensors in all of the U-phase, V-phase, and W-phase of the motor 200 (202).

As described above, deletion, replacement with another configuration, and addition of another configuration can be performed without departing from the technical idea of the present invention, and aspects thereof are also included in the scope of the present invention.

### REFERENCE SIGNS LIST

21 power semiconductor (upper arm)
22 power semiconductor (lower arm)
38 diode
100 vehicle
110 front wheel tire
120 engine
124 engine control device
130 transmission
134 transmission control device
160 differential gear
170 integrated control device
174 communication line
180 battery
184 battery control device
200 first motor
202 second motor
600 inverter device
212 housing
214 end bracket
216 bearing
218 shaft
222 gap
224 resolver
226 contact plate
230 stator
232 stator core
236 teeth
237 slot
238 stator winding
244 thermistor
280 rotor
282 rotor core
284 permanent magnet
600 inverter device
610 power module of first inverter device
620 power module of second inverter device
630 capacitor module
642 connector board
644 transmission/reception circuit
646 control circuit board
648 control circuit
650 drive circuit board
652 first drive circuit
654 drive circuit board
656 second drive circuit
660 current sensor of first motor
662 current sensor of second motor
700 thermal circuit
701 U-phase winding node
702 V-phase winding node
703 W-phase winding node
704 stator core node
705 cooling source node
706 thermal resistor between windings
707 thermal resistor between winding and stator core
708 thermal resistor between stator core and cooling source
750 torque
751 rotation speed
752 U-phase current
753 V-phase current
754 W-phase current
755 copper loss of winding (at rotation)
756 copper loss of U and W-phase windings (at stop)
757 copper loss of V-phase winding (at stop)
758 temperature of winding (at rotation)
759 temperature of U and W-phase windings (at rotation)
760 temperature of V-phase winding (at rotation)
761 torque limit ON threshold
762 torque limit OFF threshold
763 thermistor temperature
764 U, W-phase winding wire temperature estimation value
765 V-phase winding wire temperature estimation value
766 three-phase estimated value temperature difference
767 temperature estimation ON threshold (rotation speed)
768 temperature estimation OFF threshold (rotation speed)
769 temperature estimation OFF threshold (three-phase estimated value temperature difference)
770 base rotation speed

1. A motor control system that controls a motor including a three-phase motor winding including a U-phase coil, a V-phase coil, and a W-phase coil, and a thermistor that measures a temperature of any one or two of the coils of the three-phase motor winding, the motor control system comprising:
a coil temperature estimation unit that calculates an estimated temperature of each of the U-phase coil, the V-phase coil, and the W-phase coil based on a value of a current flowing through the three-phase motor winding,
wherein the motor is controlled based on the estimated temperature of the three-phase motor winding when a difference between the estimated temperatures of the three-phase motor winding is larger than a predetermined value, and
the motor is controlled based on a measured value of the thermistor when the difference between the estimated temperatures of the three-phase motor winding is equal to or less than the predetermined value.

2. The motor control system according to claim 1, wherein the motor is controlled based on the measured value of the thermistor when the difference between the estimated temperatures of the three-phase motor winding is equal to or less than the predetermined value and a rotation speed of the motor is equal to or greater than a predetermined rotation speed.

3. The motor control system according to claim 2, wherein when the rotation speed of the motor is less than the predetermined rotation speed, the motor is controlled based on the estimated temperatures of the three-phase motor winding even if the difference between the estimated temperatures of the three-phase motor winding is equal to or less than the predetermined value.

4. A method of controlling a motor including a three-phase motor winding including a U-phase coil, a V-phase coil, and a W-phase coil, and a thermistor that measures a temperature of any one or two of the coils of the three-phase motor winding, the motor control method comprising:
calculating an estimated temperature of each of the U-phase coil, the V-phase coil, and the W-phase coil based on a value of a current flowing through the three-phase motor winding;
controlling the motor based on the estimated temperature of the three-phase motor winding when a difference between the estimated temperatures of the three-phase motor winding is larger than a predetermined value; and
controlling the motor based on a measured value of the thermistor when the difference between the estimated temperatures of the three-phase motor winding is equal to or less than the predetermined value.
